(19) United States
(12) Patent Application Publication
(10) Pub. No.: US 2022/0152815 A1
(43) Pub. Date: May 19, 2022

(54) ROBOT

(71) Applicant: Mitsubishi Electric Corporation, Tokyo (JP)

(72) Inventor: Tomohisa HANAMOTO, Tokyo (JP)

(73) Assignee: Mitsubishi Electric Corporation, Tokyo (JP)

(21) Appl. No.: 17/602,288

(22) PCT Filed: Apr. 19, 2019
(86) PCT No.: PCT/JP2019/016855

§ 371 Date: Oct. 8, 2021

(51) Int. Cl. B25J 9/16; B25J 9/12; B25J 15/02; H04L 5/16; G06F 13/42

(52) U.S. Cl. CPC B25J 9/161; B25J 9/126; G06F 13/4282; H04L 5/16; B25J 15/02

(57) ABSTRACT

A robot includes a robot control device, a serial communication line, a serial communication line, position detectors that communicate data with the robot control device, and an actuator that communicates data with the robot control device. Each of the position detectors is connected to either the serial communication line or the serial communication line pair to communicate with the robot control device in half duplex, and the actuator is connected to the serial communication line and to the serial communication line to communicate with the robot control device in full duplex.

### FIELD

The present invention relates to a robot that detects movement of a robotic arm.

### BACKGROUND

A robot is constructed of a robotic arm and a robot control device that controls the robotic arm. The robotic arm includes servomotors for controlling movements of operational axes of the robotic arm, and position detectors for detecting the rotational positions of the servomotors, which are disposed in the robotic arm.

Communication between the robot control device and the position detectors is realized in a manner of one-to-one communication or in a manner of one-to-multiple communication in which two or more position detectors are connected to a single serial transmission line. In the case of one-to-one communication, as many serial transmission lines as the number of position detectors are needed, which results in an increase in wirings in the robotic arm, thereby leading to a possibility that a robot operation causes line disconnection.

The robot described in Patent Literature 1 includes multiple position detectors connected in parallel to a half-duplex serial transmission line capable of bidirectional communication, and thus allows a drive control device to output a request signal to the position detectors over a single serial transmission line so as to provide one-to-multiple communication.

### CITATION LIST

### Patent Literature

Patent Literature 1: Japanese Patent Application Laid-open No. 2006-260581

### SUMMARY

### Technical Problem

However, in the technique of Patent Literature 1 listed above, a higher number of the position detectors will reduce communication performance because a communication speed is reduced depending on the number of transmission cycles. In contrast to the position detectors, a connected device, such as an actuator, connected to the drive control device to communicate data with the drive control device sends and receives a large amount of data over a transmission line, and therefore, when the communication performance decreases, the connected device cannot carry out a desired operation. For this reason, such a connected device with a large transmission and reception amount of data is desired to communicate with the drive control device in full duplex. Addition of a wiring line for full-duplex communication to the technique of Patent Literature 1 requires separate installation of a line for full-duplex communication and a line for half-duplex communication. This has presented a problem that the number of lines increases.

The present invention has been made in view of the foregoing circumstances, and it is an object of the present invention to provide a robot that allows a connected device that is to communicate in half duplex and a connected device that is to communicate in full duplex to be both connected to the robot control device while mitigating or preventing the increase in the number of lines.

### Solution to Problem

In order to solve the problem and achieve the object, the present invention provides a robot comprising:

a robot control device; a first serial communication line pair connected to the robot control device; a second serial communication line pair connected to the robot control device; a plurality of first connected devices each of which is a device to communicate data with the robot control device; and a second connected device which is a device to communicate data with the robot control device, wherein each of the first connected devices is connected to either the first serial communication line or the second serial communication line to communicate with the robot control device in half duplex, and the second connected device is connected to the first serial communication line and the second serial communication line to communicate with the robot control device in full duplex.

### Advantageous Effects of Invention

A robot according to the present invention provides an advantageous effect that a connected device that is to communicate in half duplex and a connected device that is to communicate in full duplex can be both connected to the robot control device while mitigating or preventing the increase in the number of lines.

### BRIEF DESCRIPTION OF DRAWINGS

FIG. 1 is a diagram illustrating a configuration of a robot according to a first embodiment.

FIG. 2 is a diagram illustrating a connection configuration in the robot according to the first embodiment.

FIG. 3 is a diagram for describing a transmission cycle in the robot according to the first embodiment. FIG. 4 is a diagram illustrating a connection configuration in a robot according to a second embodiment.

FIG. 5 is a diagram illustrating an example hardware configuration of a control circuit according to the second embodiment.

### DESCRIPTION OF EMBODIMENTS

A robot according to embodiments of the present invention will be described in detail below with reference to the drawings. Note that these embodiments are not necessarily intended to limit this invention.

First Embodiment.

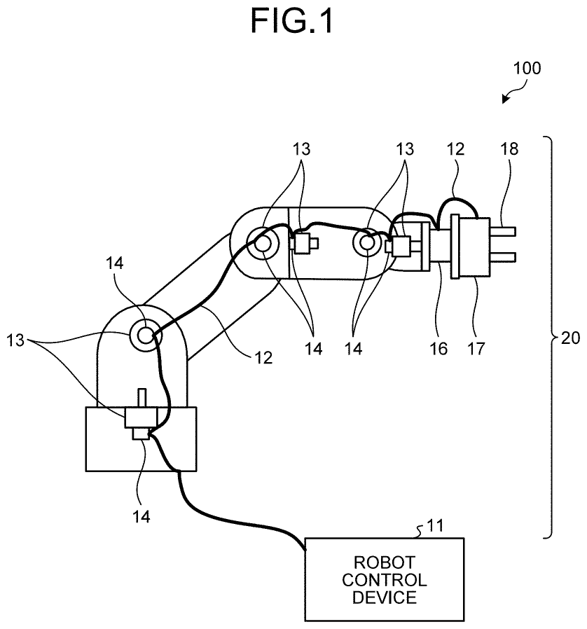

FIG. 1 is a diagram illustrating a configuration of a robot according to a first embodiment. A robot 100 includes a robotic arm 20 and a robot control device 11 that controls the robotic arm 20.

The robotic arm 20 includes multiple servomotors 13, multiple position detectors 14, a serial communication line group 12, a sensor 16, an actuator 17 that is an electric actuator, and a hand 18. The position detectors 14, the sensor 16, and the actuator 17 perform data communication with the robot control device 11.

The robotic arm 20 includes the servomotor 13 for each motion axis. The robotic arm 20 also includes the position detector 14 for each servomotor 13. FIG. 1 illustrates an example in which the robotic arm 20 has six motion axes, six servomotors 13, and six position detectors 14.

Each of the servomotors 13 drives the corresponding motion axis according to an instruction from the robot control device 11. The position detectors 14 each detect the position of the corresponding one of the servomotors 13, and send position data representing the detected position to the robot control device 11. An example of the position detectors 14 is an encoder.

The hand 18 has a function of picking an object. The actuator 17 is an example of a connected device configured to perform data communication with the robot control device 11. The actuator 17 drives the hand 18 according to an instruction from the robot control device 11, and sends data about the operational state of the actuator 17 to the robot control device 11. The data the actuator 17 sends to and receives from the robot control device 11 will be hereinafter referred to as actuator data.

An example of the sensor 16 is a pressure sensor. In a case in which the sensor 16 is a pressure sensor, the sensor 16 detects whether or not the robotic arm 20 has come into contact with another device or the like. The sensor 16 sends sensor data that is data obtained by its own detection, to the robot control device 11.

The position detectors 14 and the sensor 16 are each a first connected device, and the actuator 17 is a second connected device. The position detectors 14, the sensor 16, and the actuator 17 are connected to the robot control device 11 via the serial communication line group 12. The position detectors 14, the sensor 16, and the actuator 17 communicate data with the robot control device 11 over the serial communication line group 12. The first embodiment assumes that lower communication performance is permissible for the position detectors 14 and for the sensor 16 than communication performance permissible for the actuator 17. That is, it is assumed that the position detectors 14 and the sensor 16 can perform a desired operation even if the communication performance decreases. In other words, the amount of data transmission per transmission cycle in data communication from the robot control device 11 to the second connected device (i.e., the actuator 17) is greater than the amount of data transmission per transmission cycle in data communication from the robot control device 11 to each of the first connected devices (i.e., the position detectors 14 and the sensor 16) (i.e., the amount of data transmission for each individual one of the first connected devices). In addition, the amount of data transmission per transmission cycle in data communication from the second connected device to the robot control device 11 is greater than the amount of data transmission per transmission cycle in data communication from each of the first connected devices to the robot control device 11. The serial communication line group 12 is a set of communication lines provided to establish serial communication.

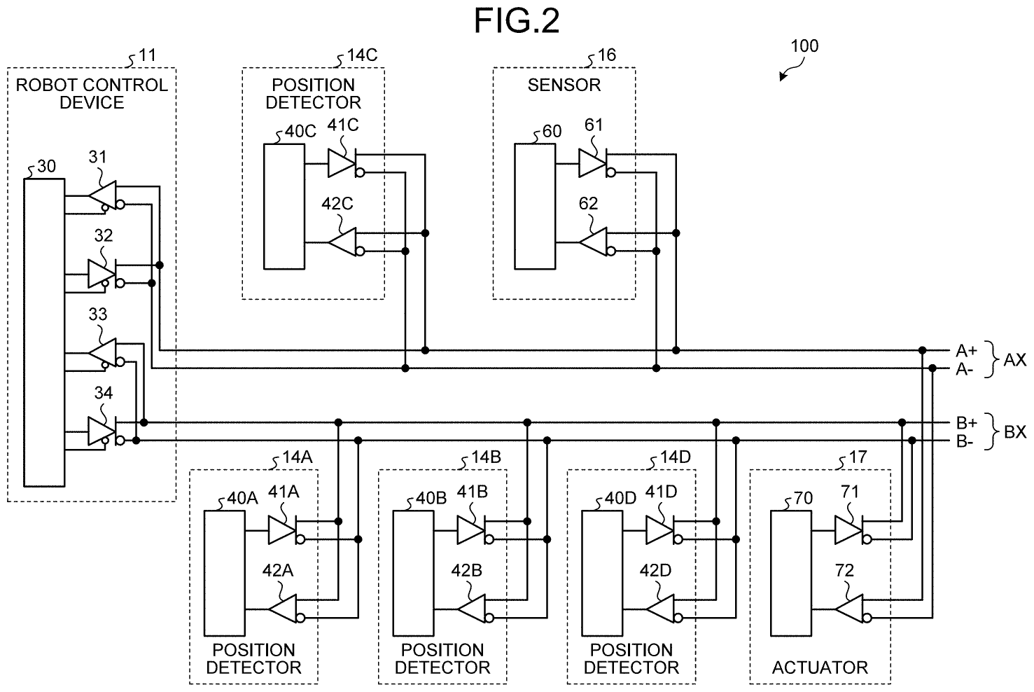

A connection configuration between the position detectors 14, the sensor 16, and the actuator 17, and the robot control device 11 will next be described. FIG. 2 is a diagram illustrating a connection configuration in the robot according to the first embodiment. FIG. 2 illustrates an example in which the position detectors 14 disposed in the robot 100 are four position detectors 14A, 14B, 14C, and 14D.

The serial communication line group 12 includes four serial communication lines. The serial communication line group 12 includes a pair of two serial communication lines (hereinafter, serial communication line pair) AX and a pair of two serial communication lines (hereinafter, serial communication line pair) BX. The serial communication line pair AX that is a first serial communication line is constructed of two serial communication lines AX(A+, A−) for differential communication. The serial communication line pair BX that is a second serial communication line is constructed of two serial communication lines BX(B+, B−) for differential communication.

The robot 100 can perform half-duplex communication over each of the serial communication lines AX(A+, A−) and BX(B+, B−), and can also perform full-duplex communication over the four communication lines, i.e., the serial communication lines AX(A+, A−) and the serial communication lines BX (B+, B−).

Hereinafter, of the serial communication line pair AX, the communication line designated as A+ (non-inverted) may be referred to as serial communication line A+, and the communication line designated as A− (inverted) may be referred to as serial communication line A−. In addition, of the serial communication line pair BX, the communication line designated as B+ (non-inverted) may be referred to as serial communication line B+, and the communication line designated as B− (inverted) may be referred to as serial communication line B−.

The position detector 14C and the sensor 16 are each connected to two communication lines, i.e., the serial communication lines A+ and A−. In addition, the position detectors 14A, 14B, and 14D are each connected to two communication lines, i.e., the serial communication lines B+ and B−. Moreover, the actuator 17 is connected to the four communication lines, i.e., the serial communication lines A+, A−, B+, and B−.

Furthermore, the robot control device 11 is connected to the four communication lines, i.e., the serial communication lines A+, A−, B+, and B−. With this configuration, the position detectors 14A to 14D and the sensor 16 communicate with the robot control device 11 in half duplex, and the actuator 17 communicates with the robot control device 11 in full duplex. This can cause each of the position detectors 14A to 14D and the sensor 16 to be used in half-duplex communication and the actuator 17 to be used in full-duplex communication, to communicate with the robot control device 11 without a decrease in communication speed.

The robot control device 11 includes a control circuit 30, differential drives 32 and 34, and differential receivers 31 and 33. The differential receiver 31 has an output terminal connected to the control circuit 30, a non-inverted input terminal connected to the serial communication line A+, and an inverted input terminal connected to the serial communication line A−.

In addition, the differential receiver 33 has an output terminal connected to the control circuit 30, a non-inverted input terminal connected to the serial communication line B+, and an inverted input terminal connected to the serial communication line B−.

Moreover, the differential drive 32 has an input terminal connected to the control circuit 30, a non-inverted output terminal connected to the serial communication line A+, and an inverted output terminal connected to the serial communication line A−.

Furthermore, the differential drive 34 has an input terminal connected to the control circuit 30, a non-inverted output terminal connected to the serial communication line B+, and an inverted output terminal connected to the serial communication line B−.

The differential drives 32 and 34 and the differential receivers 31 and 33 each have an input terminal for an enable signal. These input terminals for enable signals each receive an enable signal sent from the control circuit 30. An example of the control circuit 30 is a microcomputer.

The position detector 14A includes a control circuit 40A, a differential drive 41A, and a differential receiver 42A. The differential drive 41A has an input terminal connected to the control circuit 40A, a non-inverted output terminal connected to the serial communication line B+, and an inverted output terminal connected to the serial communication line B−. The differential receiver 42A has an output terminal connected to the control circuit 40A, a non-inverted input terminal connected to the serial communication line B+, and an inverted input terminal connected to the serial communication line B−.

The position detector 14B includes a control circuit 40B, a differential drive 41B, and a differential receiver 42B. The differential drive 41B has an input terminal connected to the control circuit 40B, a non-inverted output terminal connected to the serial communication line B+, and an inverted output terminal connected to the serial communication line B−. The differential receiver 42B has an output terminal connected to the control circuit 40B, a non-inverted input terminal connected to the serial communication line B+, and an inverted input terminal connected to the serial communication line B−.

The position detector 14D includes a control circuit 40D, a differential drive 41D, and a differential receiver 42D. The differential drive 41D has an input terminal connected to the control circuit 40D, a non-inverted output terminal connected to the serial communication line B+, and an inverted output terminal connected to the serial communication line B−. The differential receiver 42D has an output terminal connected to the control circuit 40D, a non-inverted input terminal connected to the serial communication line B+, and an inverted input terminal connected to the serial communication line B−.

The position detector 14C includes a control circuit 40C, a differential drive 41C, and a differential receiver 42C. The differential drive 41C has an input terminal connected to the control circuit 40C, a non-inverted output terminal connected to the serial communication line A+, and an inverted output terminal connected to the serial communication line A−. The differential receiver 42C has an output terminal connected to the control circuit 40C, a non-inverted input terminal connected to the serial communication line A+, and an inverted input terminal connected to the serial communication line A−.

The sensor 16 includes a control circuit 60, a differential drive 61, and a differential receiver 62. The differential drive 61 has an input terminal connected to the control circuit 60, a non-inverted output terminal connected to the serial communication line A+, and an inverted output terminal connected to the serial communication line A−. The differential receiver 62 has an output terminal connected to the control circuit 60, a non-inverted input terminal connected to the serial communication line A+, and an inverted input terminal connected to the serial communication line A−.

The actuator 17 includes a control circuit 70, a differential drive 71, and a differential receiver 72. The differential drive 71 has an input terminal connected to the control circuit 70, a non-inverted output terminal connected to the serial communication line B+, and an inverted output terminal connected to the serial communication line B−. The differential receiver 72 has an output terminal connected to the control circuit 70, a non-inverted input terminal connected to the serial communication line B+, and an inverted input terminal connected to the serial communication line B−.

The robot control device 11 sends a request command to the position detectors 14A to 14D, to the sensor 16, and to the actuator 17. Upon reception of the request command from the robot control device 11, the position detectors 14A to 14D, the sensor 16, and the actuator 17 send data corresponding to the content of the request command to the robot control device 11.

The position detectors 14A to 14D send position data to the robot control device 11. Note that in the following description, the position data sent by the position detector 14A may be referred to as position data #1; the position data sent by the position detector 14B, as position data #2; the position data sent by the position detector 14C, as position data #3; and the position data sent by the position detector 14D, as position data #4, case by case. The sensor 16 sends sensor data to the robot control device 11, and the actuator 17 sends actuator data to and receives actuator data from the robot control device 11.

As described above, the robot control device 11 communicates with the position detectors 14A, 14B, and 14D in half duplex over the serial communication lines B+ and B−, and communicates with the position detector 14C and the sensor 16 in half duplex over the serial communication lines A+ and A−. In addition, the robot control device 11 communicates with the actuator 17 in full duplex over the serial communication lines A+, A−, B+, and B−.

This allows the devices not requiring full-duplex communication (i.e., the position detectors 14A to 14D and the sensor 16) to communicate in half duplex, and allows the device requiring full-duplex communication (i.e., the actuator 17) to communicate in full duplex. This enables the robot control device 11 to ensure a certain speed of communication with the robotic arm 20, and thus to communicate with the robotic arm 20 at a suitable speed. For example, even with an increased number of the position detectors 14 connected to the robot control device 11, the robot control device 11 can perform full-duplex communication with the actuator 17, thereby making it possible to ensure a certain speed of communication with the actuator 17. In addition, even in a case of expansion (addition) of the sensor 16 or of the actuator 17, an appropriate transmission cycle can be set by appropriate assignment of wirings for the position detectors 14A, 14B, 14C, and 14D to either the serial communication line pair AX or the serial communication line pair BX.

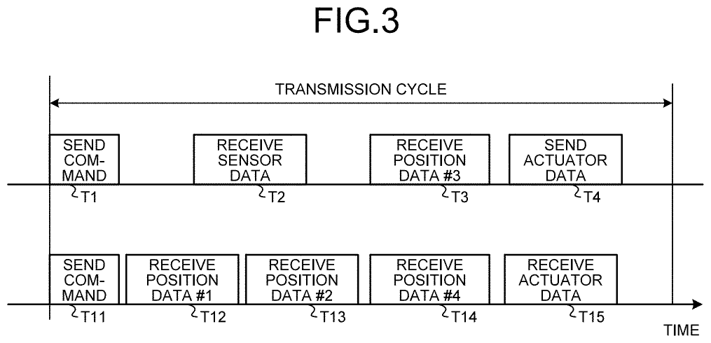

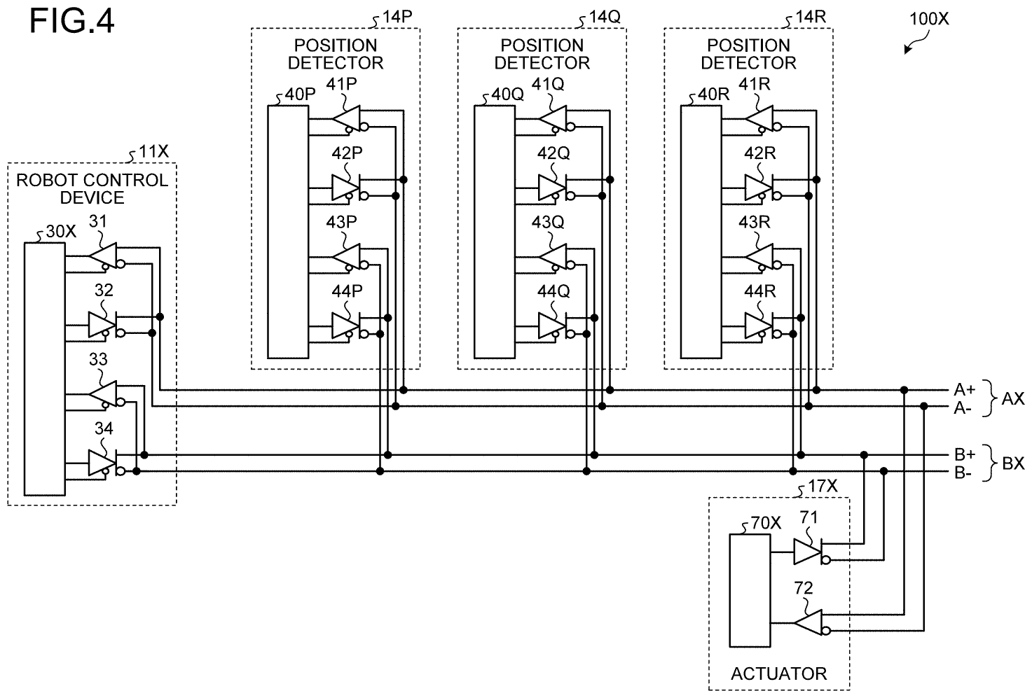

FIG. 3 is a diagram for describing a transmission cycle in the robot according to the first embodiment. The horizontal axis of FIG. 3 represents time. The upper section of FIG. 3 illustrates a signal sent and received by the robot control device 11 over the serial communication lines A+ and A−. The lower section of FIG. 3 illustrates a signal sent and received by the robot control device 11 over the serial communication lines B+ and B−.

When the robot control device 11 sends a request command over the serial communication line pair AX (T1), the position detector 14C, the sensor 16, and the actuator 17 receive this request command. Upon reception of the request command, the position detector 14C, the sensor 16, and the actuator 17 prepare data to be send to the robot control device 11.

Then, upon reception of data request instructions individually sent from the robot control device 11, the position detector 14C, the sensor 16, and the actuator 17 send, to the robot control device 11, data corresponding to each of the data request instructions. That is, the robot control device 11 performs reading data for the position detector 14C and for the sensor 16, and performs reading and writing data for the actuator 17.

Specifically, the sensor 16 sends sensor data to the serial communication line pair AX, and the robot control device 11 receives the sensor data (T2). The position detector 14C sends position data #3 to the serial communication line pair AX, and the robot control device 11 receives the position data #3 (T3). In addition, the robot control device 11 sends actuator data to the serial communication line pair AX (T4), and the actuator 17 receives the actuator data. The actuator data to be sent to the actuator 17 by the robot control device 11 is a control signal for turning on or off of gripping of the hand 18, for example.

When the robot control device 11 sends a request command over the serial communication line pair BX (T11), the position detectors 14A, 14B, and 14D and the actuator 17 receive this request command. Upon reception of the request command, the position detectors 14A, 14B, and 14D and the actuator 17 prepare data to be send to the robot control device 11.

Then, upon reception of data request instructions individually sent from the robot control device 11, the position detectors 14A, 14B, and 14D and the actuator 17 send, to the robot control device 11, data corresponding to each of the data request instructions. That is, the robot control device 11 performs reading data for the position detectors 14A, 14B, and 14D, and performs reading and writing data for the actuator 17.

Specifically, the position detector 14A sends position data #1 to the serial communication line pair BX, and the robot control device 11 receives the position data #1 (T12). The position detector 14B sends position data #2 to the serial communication line pair BX, and the robot control device 11 receives the position data #2 (T13). The position detector 14D sends position data #4 to the serial communication line pair BX, and the robot control device 11 receives the position data #4 (T14). The actuator 17 sends actuator data to the serial communication line pair BX, and the robot control device 11 receives the actuator data (T15). The actuator data received from the actuator 17 by the robot control device 11 is a signal indicating an On state or an Off state of gripping of the hand 18, for example.

The robot 100 performs the data transmission from T1 through T4 and the data transmission from T11 through T15 in parallel.

A time period from when the robot control device 11 starts command transmission of a request command over the serial communication line pair AX and the serial communication line pair BX until when the data transmission from T1 through T4 and the data transmission from T11 through T15 are both completed corresponds to the transmission cycle of the robot 100. To control timing of sending and receiving data over the serial communication line pair AX, the robot control device 11 sequentially performs data communication with the connected devices connected to the serial communication line pair AX. For example, the robot control device 11 sends a data request instruction to the sensor 16, receives sensor data from the sensor 16, then sends a data request instruction to the position detector 14C, and receives the position data #3 from the position detector 14C. After that, the robot control device 11 sends actuator data to the actuator 17. Such operation allows the robot control device 11 to coordinate reception in half-duplex communication and transmission in full-duplex communication over the serial communication line pair AX. Note that the robot control device 11 may send a data request instruction to each of the position detector 14C and the sensor 16 at a specified timing, and send the actuator data to the actuator 17 at a specified timing. That is, the robot control device 11 may perform data communication with the connected device connected to the serial communication line pair AX, in each specified cycle.

Note that although the first embodiment has been described in the context of the robot 100 that uses differential communication, the robot 100 may use a communication scheme other than differential communication. In addition, the number of connected devices that communicate in half duplex is not limited to five, but may be four or less or six or more. Moreover, the number of connected devices that communicate in full duplex is not limited to one, but may be two or more. Furthermore, a connected device of a type other than the types of the position detectors 14A to 14D and of the sensor 16 may communicate in half duplex. Still furthermore, a connected device of a type other than the actuator 17, such as an input-output device (also referred to as I/O device) that inputs and outputs an On signal and an Off signal, may communicate in full duplex.

As described above, according to the first embodiment, each of the position detectors 14A to 14D and the sensor 16 each communicate in half duplex over the serial communication line pair AX or BX, and the actuator 17 communicates in full duplex over the serial communication line pairs AX and BX. This makes it possible to connect the actuator 17 desired to communicate in full duplex to a one-to-multiple transmission line.

Second Embodiment.

A second embodiment of this invention will next be described with reference to FIG. 4. In the second embodiment, the position detectors and the actuator are each connected to both the serial communication line pairs AX and BX, and the robot control device 11 switches between half-duplex communication and full-duplex communication.

FIG. 4 is a diagram illustrating a connection configuration in the robot according to the second embodiment. Of the components of FIG. 4, components providing the same functions as those in the robot 100 of the first embodiment illustrated in FIG. 2 are designated by like reference characters, and redundant description thereof will be omitted.

A robot 100X is another example of robot, having a configuration different from the configuration of the robot 100. The robot 100X includes multiple position detectors 14 and an actuator 17X each connected to a robot control device 11X. FIG. 4 illustrates an example in which three position detectors 14P, 14Q, and 14R are used as position detectors 14 to be provided in the robot 100X.

The robot control device 11X includes a control circuit 30X, the differential drives 32 and 34, and the differential receivers 31 and 33. The control circuit 30X has a function of causing the position detectors 14P to 14R to switch between half-duplex communication and full-duplex communication, in addition to the function of the control circuit 30.

The position detector 14P includes a control circuit 40P, differential drives 42P and 44P, and differential receivers 41P and 43P. The position detector 14Q includes a control circuit 40Q, differential drives 42Q and 44Q, and differential receivers 41Q and 43Q. The position detector 14R includes a control circuit 40R, differential drives 42R and 44R, and differential receivers 41R and 43R.

The differential receivers 41P, 41Q, and 41R each have a non-inverted input terminal connected to the serial communication line A+ and an inverted input terminal connected to the serial communication line A−. The differential drives 42P, 42Q, and 42R each have a non-inverted output terminal connected to the serial communication line A+ and an inverted output terminal connected to the serial communication line A−. The differential receivers 43P, 43Q, and 43R each have a non-inverted input terminal connected to the serial communication line B+ and an inverted input terminal connected to the serial communication line B−. The differential drives 44P, 44Q, and 44R each have a non-inverted output terminal connected to the serial communication line B+ and an inverted output terminal connected to the serial communication line B−.

The differential receivers 41P and 43P each have an output terminal connected to the control circuit 40P, and the differential drives 42P and 44P each have an input terminal connected to the control circuit 40P. The differential receivers 41Q and 43Q each have an output terminal connected to the control circuit 40Q, and the differential drives 42Q and 44Q each have an input terminal connected to the control circuit 40Q. The differential receivers 41R and 43R each have an output terminal connected to the control circuit 40R, and the differential drives 42R and 44R each have an input terminal connected to the control circuit 40R.

The differential drives 42P and 44P and the differential receivers 41P and 43P each have an input terminal for an enable signal. These input terminals for enable signals receive enable signals sent from the control circuit 40P.

The differential drives 42Q and 44Q and the differential receivers 41Q and 43Q each have an input terminal for an enable signal. These input terminals for enable signals receive enable signals sent from the control circuit 40Q.

The differential drives 42R and 44R and the differential receivers 41R and 43R each have an input terminal for an enable signal. These input terminals for enable signals receive enable signals sent from the control circuit 40R.

Note that in view of the similarity of the functions and the operations performed by the control circuits 40P to 40R, the following description will be directed to a function and an operation of the control circuit 40P. The control circuit 40P has a function of switching between full-duplex communication and half-duplex communication, in addition to the function of the control circuits 40A to 40D. Specifically, the control circuit 40P has a function of sending an enable signal to each of the differential drives 42P and 44P and the differential receivers 41P and 43P according to an instruction from the robot control device 11X.

The position detector 14P also has a function of sending device identification (ID) of the position detector 14P to the robot control device 11X. In addition, the actuator 17X includes a control circuit 70X in place of the control circuit 70 as compared to the actuator 17. The control circuit 70X has a function of sending a device ID of the actuator 17X to the robot control device 11X, in addition to the function of the control circuit 70. That is, in the robot 100X, a connected device connected to the robot control device 11X has a function of sending its own device ID of that connected device to the robot control device 11X. A device ID is identification information unique to each connected device. One example of the device ID is a product ID of a connected device.

At the time of communication initialization, the control circuit 30X of the robot control device 11X determines which of half duplex communication and full duplex communication to cause each connected device should be caused to perform, based on the number of, and the types of, the connected devices connected to the robot control device 11X. The control circuit 30X also selects over which of the serial communication line pair AX and the serial communication line pair BX the half-duplex communication is to be performed for the connected device(s) caused to communicate in half duplex, and accordingly makes setting. The following description of the second embodiment is directed to a case in which the control circuit 30X causes the position detectors 14P to 14R to communicate in half duplex, and causes the actuator 17X to communicate in full duplex.

At the time of communication initialization, the control circuit 30X sends a command to request the device ID, to the connected device(s). The connected devices each send the device ID stored in that connected device to the robot control device 11X. Upon reception of the device IDs from the connected devices, the control circuit 30X identifies the number of, and the types of, the connected devices based on the device IDs received, and determines overall communication load of the serial communication line pairs AX and BX based on the result of identification. Note that the control circuit 30X may determine the communication load based on the number of the position detectors 14. That is, the control circuit 30X may determine the communication load based on the number of connected devices not requiring full-duplex communication (i.e., the position detector(s) 14, the sensor 16, etc.).

The communication load varies depending on the type of a connected device, and for this reason, the robot control device 11X preliminarily stores information on the communication load (hereinafter referred to as load information) for each of the device IDs of connected devices.

Meanwhile, the robot control device 11X is connected with a first connected device that is a connected device not requiring full duplex communication, and with a second connected device that is a connected device requiring full duplex communication. To identify these connected devices, the robot control device 11X preliminarily stores information (hereinafter referred to as specifying information) that specifies the device ID(s) of the connected device(s) permitted to communicate in half duplex and the device ID(s) of the connected device(s) not permitted to communication in half duplex. Examples of connected devices that do not require full duplex communication are the position detectors 14P to 14R, and an example of a connected device that requires full duplex communication is the actuator 17X. A connected device requiring in full duplex communication needs a higher communication speed than a connected device not requiring in full duplex communication.

The control circuit 30X determines an overall communication load of the serial communication line pairs AX and BX based on the number of, and the types of, the connected devices and the load information, and determines which of full duplex communication and half duplex communication each connected device is caused to perform, based on the determination result on the load. For example, when the number of the connected devices is greater than a threshold, the control circuit 30X determines that a connected device that does not require to communicate in full duplex should be caused to communicate in half duplex.

When a connected device is caused to communicate in half duplex, the control circuit 30X determines which of the connected devices should be caused to communicate in half duplex, based on the specifying information. In the second embodiment, the control circuit 30X determines that the position detectors 14P to 14R should be caused to communicate in half duplex.

The control circuit 30X selects either the serial communication line pair AX or the serial communication line pair BX for each of the position detectors 14P to 14R based on the load information. The control circuit 30X assigns either the serial communication line pair AX or the serial communication line pair BX to each of the position detectors 14P to 14R so that the difference between the communication load on the serial communication line pair AX and the communication load on the serial communication line pair BX is minimized. By suitable assignment of the numbers of the position detectors 14P to 14R (the numbers of stations) that will use the serial communication line pair AX and the serial communication line pair BX, the control circuit 30X can reduce the transmission delay. Meanwhile, the control circuit 30X determines that the actuator 17X should be caused to perform full duplex communication.

The control circuit 30X sends a command specifying either the serial communication line pair AX or the serial communication line pair BX to a connected device determined to be caused to communicate in half duplex. Accordingly, a connected device that has received a command specifying the serial communication line pair AX enables the serial communication line pair AX, and disables the serial communication line pair BX. Similarly, a connected device that has received a command specifying the serial communication line pair BX enables the serial communication line pair BX, and disables the serial communication line pair AX. This causes the position detectors 14P to 14R to each communicate with the robot control device 11 in half duplex using the specified one of the serial communication line pair AX and the serial communication line pair BX.

The control circuit of each of the position detectors switches between an enabled state and a disabled state of the serial communication line pairs AX and BX by inputting enable signals to the differential drives and to the differential receivers. For example, upon reception of a command specifying the serial communication line pair AX from the control circuit 30X, the control circuit 40P of the position detector 14P inputs on-state enable signals to the differential receiver 41P and the differential drive 42P, and inputs off-state enable signals to the differential receiver 43P and the differential drive 44P.

Such operation causes the position detectors 14P to 14R to communicate in half duplex, and causes the actuator 17X to communicate in full duplex. For example, when a connected device is newly connected to the serial communication line pair AX or BX, the robot 100X determines whether or not to cause each connected device to communicate in half duplex. In addition, when a connected device is disconnected from the serial communication line pair AX or BX, the robot 100X determines whether or not to cause each connected device to communicate in half duplex.

Note that although the second embodiment has been described in the context of the robot 100X that uses differential communication, the robot 100X may use a communication scheme other than differential communication. In addition, the number of connected devices connected to the robot control device 11X is not limited to four, but may be three or less or five or more. In addition, the robot control device 11X may be connected with a connected device of another type, such as the sensor 16. In this case, similarly to the position detectors 14P to 14R, the control circuit of the connected device of the other type has a function of sending a device ID to the robot control device 11X and a function of outputting an enable signal.

The robot control device 11X switches between half-duplex communication and full-duplex communication with the connected device of the other type by an operation similar to the operation for the position detectors 14P to 14R.

As described above, the robot control device 11X makes setting such that a connected device not requiring communication in full duplex is caused to communicate in half duplex, based on the number of, and the types of, the connected devices. In addition, the robot control device 11X assigns either the serial communication line pair AX or the serial communication line pair BX to a connected device set to communicate in half duplex so that the difference between the communication load on the serial communication line pair AX and the communication load on the serial communication line pair BX is reduced. That is, the robot control device 11X assigns each of the position detectors 14P to 14R to either the serial communication line pair AX or the serial communication line pair BX. By so doing, the robot control device 11X can ensure a certain speed of communication with the robotic arm 20, and thus making it possible to communicate with the robotic arm 20 at a suitable speed. Moreover, ensuring a certain communication speed allows sensors or actuators to be added in addition to the position detectors 14.

As described above, in the second embodiment, the position detectors 14P to 14R are connected to both the serial communication line pair AX and the serial communication line pair BX. The robot control device 11X then causes the position detectors 14P to 14R to communicate in half duplex over either the serial communication line pair AX or the serial communication line pair BX when the number of the position detectors 14 is greater than a threshold. This enables the robot 100X to reduce the communication load on the serial communication line pairs AX and BX when the number of the position detectors 14 is greater than a threshold.

Hardware configurations of the control circuits 30, 30X, 40A-40D, 40P-40R, 60, 70, and 70X will now be described. Note that in view of the similarity of the hardware configurations of the control circuits 30, 30X, 40A-40D, 40P-40R, 60, 70, and 70X, a hardware configuration of the control circuit 30X will be described in the following description.

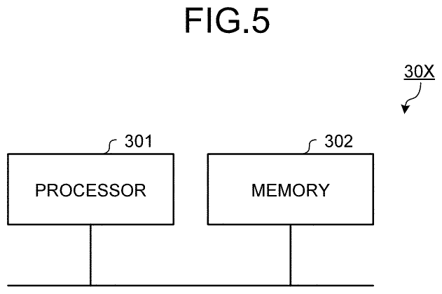

FIG. 5 is a diagram illustrating an example hardware configuration of the control circuit according to the second embodiment. The control circuit 30X can be implemented by a processor 301 and a memory 302 illustrated in FIG. 5. Examples of the processor 301 include a CPU (central processing unit; also known as central processing device, processing unit, computing device, microprocessor, microcomputer, processor, and digital signal processor (DSP)) and a system large scale integration (LSI). Examples of the memory 302 include a random access memory (RAM) and a read-only memory (ROM).

The control circuit 30X is implemented by the processor 301 reading and executing a program, stored in the memory 302, the program being configured to perform an operation of the control circuit 30X. It can also be said that this program causes a computer to perform a procedure or method for the control circuit 30X. The memory 302 is also used as a temporary memory when the processor 301 performs various processing tasks.

A program executed by the processor 301 may be in a form of a computer program product including a computer-readable non-transitory recording medium including multiple computer-executable instructions for performing data processing. The program executed by the processor 301 causes a computer to perform such a process that multiple instructions carry out data processing.

Alternatively, the control circuit 30X may be implemented by a dedicated hardware set. Further alternatively, the function of the control circuit 30X may be implemented partially in a dedicated hardware, and the remainder may be implemented in software or firmware.

The configurations described in the foregoing embodiments are merely examples of the contents of the present invention, and may each be combined with other publicly known techniques and partially omitted and/or modified without departing from the scope of the present invention.

### REFERENCE SIGNS LIST

11, 11X robot control device; 12 serial communication line group; 13 servomotor; 14, 14A, 14B, 14C, 14D, 14P, 14Q, 14R position detector; 16 sensor; 17, 17X actuator; 18 hand; 20 robotic arm; 30, 30X, 40A-40D, 40P-40R, 60, 70, 70X control circuit; 31, 33, 41P-41R, 42A-42D, 43P-43R, 62, 72 differential receiver; 32, 34, 41A-41D, 42P-42R, 44P-44R, 61, 71 differential drive; 100, 100X robot; AX, BX serial communication line pair.

1. A robot comprising:
a robot control device;
a first serial communication line connected to the robot control device;
a second serial communication line connected to the robot control device;
a plurality of first connected devices each of which is a device to communicate data with the robot control device; and
a second connected device which is a device to communicate data with the robot control device, wherein
each of the first connected devices is connected to either the first serial communication line or the second serial communication line to communicate with the robot control device in half duplex, and
the second connected device is connected to the first serial communication line and the second serial communication line to communicate with the robot control device in full duplex.

2. The robot according to claim 1, wherein
the each of the first connected devices is connected to either the first serial communication line or the second serial communication line so that a difference between a communication load on the first serial communication line and a communication load on the second serial communication line is minimized.

3. A robot comprising:
a robot control device;
a first serial communication line connected to the robot control device;
a second serial communication line connected to the robot control device;
a plurality of first connected devices each of which is a device to communicate data with the robot control device; and
a second connected device which is a device to communicate data with the robot control device, wherein
the first connected devices and the second connected device are each connected to the first serial communication line and the second serial communication line,
upon reception of an instruction from the robot control device, each of the first connected devices communicates with the robot control device in half duplex over any of the first serial communication line and the second serial communication line according to the instruction, and
the second connected device communicates with the robot control device in full duplex.

4. The robot according to claim 3, wherein
the robot control device sends a command to each of the first connected devices and the second connected device, the command being set to request identification information of that connected device,
each of the first connected devices and the second connected device sends identification information stored in that connected device, to the robot control device,
the robot control device identifies the number of the first connected devices and the second connected device connected to the robot control device based on the identification information, determines which of half duplex communication and full duplex communication the first connected devices should be caused to perform, based on a result of identification, and when half duplex communication is realized, sends a command specifying either the first serial communication line or the second serial communication line, to each of the first connected devices, and
the first connected devices perform the half duplex communication with the robot control device over the first serial communication line specified or the second serial communication line specified.

5. The robot according to claim 4, wherein the robot control device assigns either the first serial communication line or the second serial communication line to each of the first connected devices so that a difference between a communication load on the first serial communication line and a communication load on the second serial communication line is minimized.

6. The robot according to claim 1, wherein data communication from the robot control device to the second connected device is greater in amount of data transmission per transmission cycle than data communication from the robot control device to the each of the first connected devices.

7. The robot according to claim 1, wherein
the robot control device controls servomotors that drive motion axes of a robotic arm, and an actuator that drives a hand of the robotic arm,
the first connected devices are position detectors to detect rotational positions of the servomotors, and
the second connected device is the actuator.

8. The robot according to claim 2, wherein
data communication from the robot control device to the second connected device is greater in amount of data transmission per transmission cycle than data communication from the robot control device to the each of the first connected devices.

9. The robot according to claim 3, wherein
data communication from the robot control device to the second connected device is greater in amount of data transmission per transmission cycle than data communication from the robot control device to the each of the first connected devices.

10. The robot according to claim 4, wherein
data communication from the robot control device to the second connected device is greater in amount of data transmission per transmission cycle than data communication from the robot control device to the each of the first connected devices.

11. The robot according to claim 5, wherein
data communication from the robot control device to the second connected device is greater in amount of data transmission per transmission cycle than data communication from the robot control device to the each of the first connected devices.

12. The robot according to claim 2, wherein
the robot control device controls servomotors that drive motion axes of a robotic arm, and an actuator that drives a hand of the robotic arm,
the first connected devices are position detectors to detect rotational positions of the servomotors, and
the second connected device is the actuator.

13. The robot according to claim 3, wherein
the robot control device controls servomotors that drive motion axes of a robotic arm, and an actuator that drives a hand of the robotic arm,
the first connected devices are position detectors to detect rotational positions of the servomotors, and
the second connected device is the actuator.

14. The robot according to claim 4, wherein
the robot control device controls servomotors that drive motion axes of a robotic arm, and an actuator that drives a hand of the robotic arm,
the first connected devices are position detectors to detect rotational positions of the servomotors, and
the second connected device is the actuator.

15. The robot according to claim 5, wherein
the robot control device controls servomotors that drive motion axes of a robotic arm, and an actuator that drives a hand of the robotic arm,
the first connected devices are position detectors to detect rotational positions of the servomotors, and
the second connected device is the actuator.

16. The robot according to claim 6, wherein
the robot control device controls servomotors that drive motion axes of a robotic arm, and an actuator that drives a hand of the robotic arm,
the first connected devices are position detectors to detect rotational positions of the servomotors, and
the second connected device is the actuator.

17. The robot according to claim 8, wherein
the robot control device controls servomotors that drive motion axes of a robotic arm, and an actuator that drives a hand of the robotic arm,
the first connected devices are position detectors to detect rotational positions of the servomotors, and
the second connected device is the actuator.

18. The robot according to claim 9, wherein
the robot control device controls servomotors that drive motion axes of a robotic arm, and an actuator that drives a hand of the robotic arm,
the first connected devices are position detectors to detect rotational positions of the servomotors, and
the second connected device is the actuator.

19. The robot according to claim 10, wherein
the robot control device controls servomotors that drive motion axes of a robotic arm, and an actuator that drives a hand of the robotic arm,
the first connected devices are position detectors to detect rotational positions of the servomotors, and
the second connected device is the actuator.

20. The robot according to claim 11, wherein
the robot control device controls servomotors that drive motion axes of a robotic arm, and an actuator that drives a hand of the robotic arm,
the first connected devices are position detectors to detect rotational positions of the servomotors, and
the second connected device is the actuator.
